(19) United States
(12) Patent Application Publication
(10) Pub. No.: US 2024/0381027 A1
(43) Pub. Date: Nov. 14, 2024

(54) ACOUSTIC RECORDING DEVICE HAVING WI-FI TO MULTICAST AUDIO

(71) Applicant: WILDLIFE ACOUSTICS, INC., Maynard, MA (US)

(72) Inventors: Ian Agranat, Concord, MA (US); Sherwood Kenneth Snyder, Ithaca, NY (US); Andrew Patrick Moroney, Northborough, MA (US)

(21) Appl. No.: 18/144,548

(22) Filed: May 8, 2023

(51) Int. Cl. H04R 3/12; G06F 3/16

(52) U.S. Cl. CPC H04R 3/12; G06F 3/162; H04R 2420/07; H04R 2430/01

(57) ABSTRACT

Examples of the disclosure include a bioacoustic recording device having one or more sensors configured to sense bioacoustic information, processing circuitry configured to process the bioacoustic information, a wireless communication interface configured to be communicatively coupled to a plurality of external devices, and at least one controller configured to control the one or more sensors to sense the bioacoustic information, control the processing circuitry to process the bioacoustic information and output processed bioacoustic information, and control the wireless communication interface to wirelessly transmit the processed bioacoustic information to the plurality of external devices.

### BACKGROUND

### 1. Field of the Disclosure

At least one example in accordance with the present disclosure relates generally to acoustic recording devices.

### 2. Discussion of Related Art

Acoustic recording devices record acoustic information. Acoustic recording devices may include one or more microphones to record and store acoustic information. Some acoustic recording devices may be used to record bioacoustics information, that is, information related to animal sounds. For example, animal sounds may include vocalizations of various animals.

### SUMMARY

According to at least one aspect of the present disclosure, a bioacoustic recording device is provided comprising one or more sensors configured to sense bioacoustic information, processing circuitry configured to process the bioacoustic information, a wireless communication interface configured to be communicatively coupled to a plurality of external devices, and at least one controller configured to control the one or more sensors to sense the bioacoustic information, control the processing circuitry to process the bioacoustic information and output processed bioacoustic information, and control the wireless communication interface to wirelessly transmit the processed bioacoustic information to the plurality of external devices.

In some examples, the at least one controller is configured to control the wireless communication interface to broadcast the processed bioacoustic information. In various examples, the at least one controller is configured to control the wireless communication interface to multicast the processed bioacoustic information to each external device of the plurality of external devices simultaneously. In some examples, the at least one controller is configured to control the wireless communication interface to unicast the processed bioacoustic information to each external device of the plurality of external devices sequentially.

In various examples, the wireless communication interface is configured to be communicatively coupled to and receive instructions from an interface device, and wherein the at least one controller is further configured to pair with the plurality of external devices responsive to receiving the instructions from the interface device. In some examples, the at least one controller is further configured to adjust a gain of a transmission power of the wireless communication interface responsive to receiving, from the interface device, instructions to adjust the gain. In various examples, the at least one controller is further configured to adjust a sample rate of the one or more sensors responsive to receiving, from the interface device, instructions to adjust the sample rate.

According to at least one example of the disclosure, a method of wirelessly transmitting bioacoustic information from a bioacoustic recording device is provided, the method comprising sensing, by one or more sensors of the bioacoustic recording device, bioacoustic information, processing, by processing circuitry of the bioacoustic recording device, the bioacoustic information to output processed bioacoustic information, and wirelessly transmitting, via a wireless communication interface, the processed bioacoustic information to a plurality of external devices.

In some examples, the method includes broadcasting, by the wireless communication interface, the processed bioacoustic information. In various examples, the method includes multicasting, by the wireless communication interface, the processed bioacoustic information to each external device of the plurality of external devices simultaneously. In some examples, the method includes unicasting, by the wireless communication interface, the processed bioacoustic information to each external device of the plurality of external devices sequentially.

In various examples, the method includes receiving, from an interface device via the wireless communication interface, instructions to pair with the plurality of external devices, and pairing the bioacoustic recording device with the plurality of external devices responsive to receiving the instructions from the interface device. In some examples, the method includes adjusting a gain of a transmission power of the wireless communication interface responsive to receiving. from the interface device, instructions to adjust the gain. In various examples, the method includes adjusting a sample rate of the one or more sensors responsive to receiving, from the interface device, instructions to adjust the sample rate.

According to at least one example of the disclosure, a non-transitory computer-readable medium storing thereon sequences of computer-executable instructions for wirelessly transmitting bioacoustic information from a bioacoustic recording device is provided, the sequences of computer-executable instructions including instructions that instruct at least one processor to control one or more sensors to sense bioacoustic information, control processing circuitry to process the bioacoustic information and output processed bioacoustic information; and control a wireless communication interface to wirelessly transmit the processed bioacoustic information to a plurality of external devices.

In some examples, the at least one processor is configured to control the wireless communication interface to broadcast the processed bioacoustic information. In various examples, the at least one processor is configured to control the wireless communication interface to multicast the processed bioacoustic information to each external device of the plurality of external devices simultaneously. In some examples, the at least one processor is configured to control the wireless communication interface to unicast the processed bioacoustic information to each external device of the plurality of external devices sequentially.

In various examples, the at least one processor is further configured to adjust a gain of a transmission power of the wireless communication interface responsive to receiving, from an interface device, wireless instructions to adjust the gain. In some examples, the at least one processor is further configured to adjust a sample rate of the one or more sensors responsive to receiving, from the interface device, instructions to adjust the sample rate.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a block diagram of a bioacoustic recording device according to an example; and

FIG. 2 illustrates a process of operating the bioacoustic recording device according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, clement or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

As discussed above, acoustic recording devices may be used to record animal sounds. For example, acoustic recording devices may be used to record bioacoustics information produced by bats. Some acoustic recording devices may be deployed by an operator (for example, a researcher or bat enthusiast) in a location where bats are active. Such acoustic recording devices may collect acoustic information, which may include bat echolocation calls, over a period of time until the operator re-collects the device. In some examples, the acoustic recording devices may remain deployed and may be connected to a remote display and/or power source. For example, a deployed acoustic recording device may receive power from, and provide data to, a remote site such as tourist or research center to provide real-time acoustic information to the site. In other cases, an operator may keep the acoustic recording device with her. For example, an acoustic recording device may be a handheld device used by an operator (for example, a researcher, tour guide, tour participant, and so forth) walking through a bat habitat. For example, a tour guide holding the handheld device may be leading a “bat walk” for a group of tour participants. Each of the tour participants may be given their own acoustic recording device which may, for example, connect to the participant's smartphone. Each user's smartphone may execute a smartphone application (or “app”) to interface with the acoustic recording device. The acoustic recording device may capture acoustic information, and the smartphone application may analyze the acoustic information. The smartphone application may then output information based on the analysis, such as by displaying spectrograms showing the bat calls or playing audio information representing the bat calls but within a human-audible range. In other examples, the acoustic recording device may be a standalone device used by tour participants separately from their smartphones.

Acoustic recording devices which interface with a user's smartphone advantageously reduces the computational and display requirements of the acoustic recording device itself. However, certain smartphone platforms may require certain proprietary connectors to connect to the acoustic recording devices. Furthermore, as smartphones are updated and new smartphones are released, changes may need to be made to the acoustic recording device to enable communication with new and updated smartphones. In some examples, the acoustic recording devices may draw power from the smartphone connected thereto, which may be undesirable for users. Furthermore, despite the advantages offered by utilizing certain functionality of a smartphone, acoustic recording devices may still be costly to outfit a large group of people with (for example, an entire tour group).

Examples of the disclosure provide acoustic recording devices with wireless-data-transfer functionalities, including multicast, broadcast, and/or round-robin unicast capabilities. In some examples, acoustic recoding devices may communicate acoustic information over a wireless-communication protocol, such as Wi-Fi. By enabling wireless communication, acoustic information may be transmitted to remote destinations or devices. For example, a tour operator guiding a group of tour participants on a bat walk may capture acoustic information with a single device and wirelessly transmit the acoustic information to the smartphone of each tour participant without the participants needing any additional devices. In another example, acoustic recording devices may be deployed in a remote location, and acoustic information captured by the acoustic recording devices may be transmitted to a remote site that is more convenient or useful to a user. In still other examples, different implementations may be utilized.

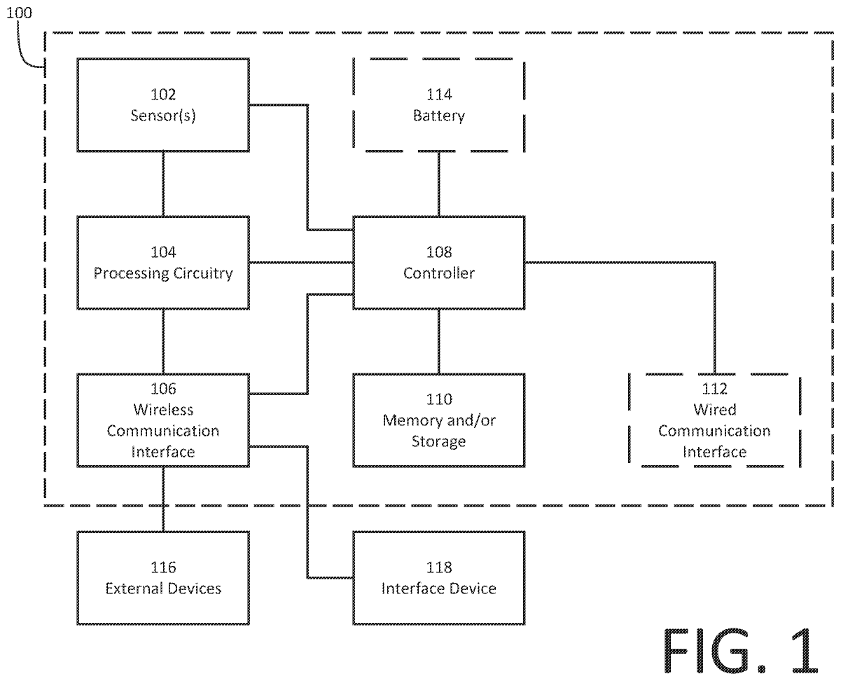

FIG. 1 illustrates a block diagram of an acoustic recording device 100 (“device 100”) according to an example. The device 100 includes one or more sensors 102 (“sensors 102”), processing circuitry 104 (“circuitry 104”), at least one wireless communication interface 106 (“wireless interface 106”), at least one controller 108 (“controller 108”), memory and/or storage 110 (“memory 110”), and, optionally, at least one wired communication interface 112 (“wired interface 112”), and/or at least one battery 114 (“battery 114”). As discussed in greater detail below, the interfaces 106, 112 may facilitate the transmission of power in some examples and may not be limited to data communications.

The sensors 102 may be coupled to the circuitry 104 and the controller 108. In some examples, the sensors 102 may be coupled to the battery 114. The sensors 102 may include sensors such as acoustic sensors (for example, ultrasonic sensors), temperature sensors, light sensors, or any other types of sensors. The sensors 102 may be configured to sense information. such as bat echolocation calls and/or other bioacoustic information, and provide the sensed information at least to the circuitry 104 and/or the controller 108.

The circuitry 104 may be coupled to the sensors 102, the wireless interface 106, and the controller 108. In some examples, the circuitry 104 may be coupled to the battery 114. The circuitry 104 may include signal-processing circuitry, such as amplifiers, filters, ADCs, modems, and so forth. The circuitry 104 may include components to process sensed information received from the sensors 102. The circuitry 104 may be configured to process the sensed information and deliver the processed information to the wireless interface 106 (for example, to be transmitted externally) and/or to the controller 108 (for example, to be stored in the memory and/or storage 110).

The wireless interface 106 may be coupled to the circuitry 104 and the controller 108, and may be configured to be coupled to one or more external devices 116 (“external devices 116”) and/or one or more interface devices 118 (“interface device 118”). In some examples, the wireless interface 106 may be coupled to the battery 114. The wireless interface 106 may include one or more components to enable wireless communication with the external devices 116 and/or the interface device 118, such as one or more antennas configured to transmit and/or receive information to the external devices 116 and/or interface device 118.

The external devices 116 and interface device 118 may include any computing devices, such as smartphones, tablets, laptops, desktop computers, and so forth. For example, the interface device 118 may be a smartphone operated by a tour guide and the external devices 116 may be smartphones operated by tour participants. The tour guide may interface with and/or control the device 100 via using the interface device 118, such as by controlling the device 100 to acquire acoustic information on a bat walk. For example, the sensors 102 may sense acoustic information containing bat-echolocation sounds, the circuitry 104 may process the acoustic information to prepare the acoustic information for wireless transmission, and the external devices 116 may transmit the processed acoustic information via one or more antennas to the external devices 116. Accordingly, the interface device 118 may act as an interface between a tour operator and the device 100, and the external devices 116 may act as interfaces between tour participants and the device 100.

The controller 108 may be coupled to the sensors 102, the circuitry 104, the wireless interface 106, the memory 110, and the wired interface 112. In some examples, the controller 108 may be coupled to the battery 114. The controller 108 may include one or more processors to control operation of the device 100. For example, the controller 108 may control and/or configure the sensors 102 to sense information, may control the circuitry 104 to process the sensed information, may control the wireless interface 106 to wirelessly transmit and/or receive information, may store and/or retrieve information from the memory 110, may control the wired interface 112 to transmit and/or receive information via a wired connection, and so forth. In some examples, the controller 108 may route power derived from the battery 114 to one or more loads, such as the components 102-112 of the device 100.

The memory 110 is coupled to the controller 108. In some examples, the memory 110 may be coupled to the battery 114. The memory 110 may include volatile and/or non-volatile memory and/or storage. The memory 110 may communicate with the controller 108 to provide the memory used in executing one or more applications. The memory 110 may also enable longer-term data storage, such as by storing sensed data sensed by the sensors 102.

The wired interface 112 may be coupled to the controller 108. In some examples, the wired interface 112 may be coupled to the battery 114. In some examples, the wired interface 112 may include one or more components to enable wired communication with one or more devices, such as external devices (for example, smartphones, laptops, or other computing devices) or power sources (for example, to recharge the battery 114). In examples in which the wired interface 112 is included, the wired interface 112 may include one or more communication and/or power ports (for example, USB ports) configured to send and/or receive information and/or power with devices or power sources. In some examples, the device 100 may exchange communications primarily or exclusively via the wireless interface 106, and may use the wired interface 112 primarily or exclusively to receive power to recharge the battery 114. In other examples, the device 100 may be coupled to external devices and/or power sources via the wireless interface 106, and the wired interface 112 may optionally be omitted.

The battery 114 may be coupled to the sensors 102, the circuitry 104, the wireless interface 106, the controller 108, the memory 110, and/or the wired interface 112. The battery 114 may include one or more batteries and/or one or more battery cells to store electrical power. The battery 114 may be rechargeable in some examples. In various examples, the battery 114 may include a battery-management system and/or charging circuitry. The charging circuitry may be coupled to (and configured to receive power from) the wired interface 112 (for example, if the battery 114 is configured to be recharged via a wired connection) and/or the wireless interface 106 (for example, if the battery 114 is configured to be recharged via wireless inductive charging). In these examples, the interface device 118 may include a power source, such as a smartphone, power converter, external battery, and/or other device capable of providing recharging power to the battery 114. In various examples, the battery 114 may include, or be replaced by, other energy-storage devices, such as ultracapacitors. In some examples, the battery 114 may be omitted completely. For example, the device 100 may receive power from the interface device 118 via the wired interface 112 and may therefore be powered without including an energy-storage device.

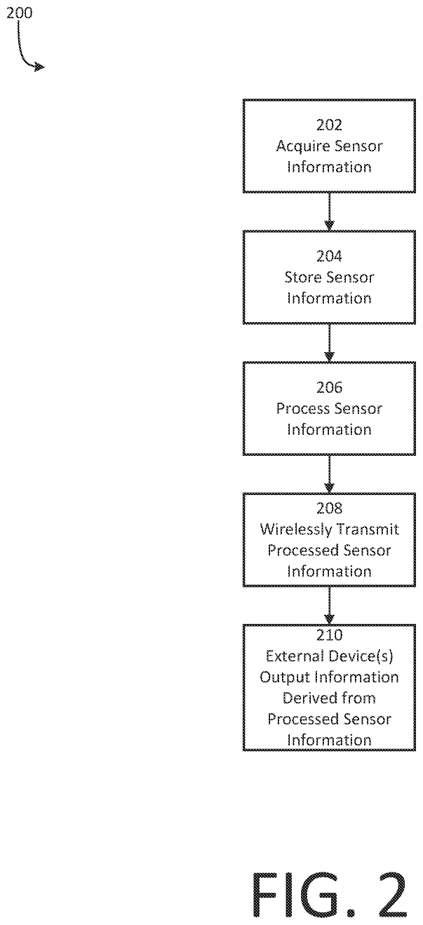

FIG. 2 illustrates a process 200 of operating the device 100 according to an example. The process 200 may be executed at least partially by the controller 108. In some examples, a user (for example, a tour guide) may use the interface device 118 to communicate with, and provide instructions to, the device 100 via the controller 108. The interface device 118 may execute a smartphone application to control the device 100, for example. The user may use the smartphone application to instruct the device 100 to execute the process 200. For example, the user may be a tour guide leading a group of tour participants on a bat walk, and may instruct the device 100 to execute the process 200 when the user is ready to begin capturing bioacoustic information.

At act 202, the controller 108 controls the sensors 102 to acquire sensor information. In some examples, the sensors 102 may include acoustic sensors, such as microphones, to capture bioacoustic information produced by animal calls, such as bat echolocation calls. In various examples, a user may be able to select a sample rate of the sensors 102 via the interface device 118.

At act 204, the controller 108 stores the sensor information. For example, the controller 108 may store the sensor information acquired by the sensors 102 in the memory 110. In some examples, the controller 108 may store the sensor information acquired by the sensors 102 in non-volatile memory of the memory 110.

At act 206, the controller 108 controls the circuitry 104 to process the sensor information. For example, the controller 108 may control the circuitry 104 to amplify and/or filter the sensor information, convert analog sensor information to digitized sensor information, and so forth.

At act 208, the controller 108 controls the wireless interface 106 to transmit the processed sensor information to the external devices 116 and, in some examples, to the interface device 118. For example, the circuitry 104 and/or the wireless interface 106 may include a wireless modem configured to transmit the processed sensor information (for example, via broadcast, multicast, round-robin unicast, and so forth). In some examples, the controller 108 may control the circuitry 104 and/or the wireless interface 106 to packetize the processed sensor information into a stream of audio packets (for example, UDP/IP packets, TCP/IP packets, and so forth) for wireless transmission. In some examples, the controller 108 controls the wireless interface 106 to transmit the processed audio information pursuant to a Wi-Fi communication protocol (for example, one or more of the IEEE 802.11 protocols), a Bluetooth communication protocol, or another communication protocol.

At act 210, the external devices 116 output information derived from the processed sensor information. As discussed above, the external devices 116 may include smartphones executing smartphone applications which may act as companion applications to the device 100. The external devices 116 may be configured to receive and interpret the processed sensor information, and output information or signals derived from the processed sensor information. For example, the external devices 116 may store data files encoding the processed sensor information for later analysis or playback, display a spectrogram (for example, a static, dynamic, or scrolling spectrogram) derived from the processed sensor data, analyze the processed sensor information to automatically detect characteristics of the animal captured by the processed sensor information (for example, by automatically detecting the genus or species of the animal, detecting a sex of the animal, detecting an approximately age of the animal, and so forth), output an audio signal derived from the processed sensor data (which may itself be in the ultrasonic frequency range and thus initially inaudible to a user) using techniques such as heterodyne, zero-crossing, and/or time expansion, and so forth.

Accordingly, in an example in which the external devices 116 include tour participants' smartphones, the tour participants may view and/or hear visual and/or audio information captured by the device 100. A tour guide may provide instructions to operate the device 100 via the interface device 118. However, the device 100 may be implemented in additional or different configurations or situations.

For example, rather than being used on a bat walk, the device 100 may be deployed in a remote location to collect and wirelessly transmit sensor information without being physically held, or near, a human operator. In various examples, the device 100 may be deployed in a natural animal habitat, such as a bat habitat, frog habitat, bird habitat, insect habitat, or other type of habitat. For example, the device 100 may be affixed to a tripod and left in the animal habitat. A human operating the external devices 116 and/or interface device 118, which may include one or more smartphones, computers, tablets, or other devices, may be located at a remote site, such as within a visitor or research center. For example, the external devices 116 may include a public television display to output visual and/or audio information to visitors or researchers. Information acquired from the remote animal habitat may be transmitted to the devices 116 and/or 118 in real-time for viewers to experience.

The foregoing example implementations are provided for purposes of example rather than limitation. The external devices 116 and/or interface device 118 may include any kind of computing devices (and, as discussed above, power sources in some examples) deployed in any of various configurations where it may be desirable for the device 100 to wirelessly transmit sensor information to one or more destinations. Furthermore, although examples are provided above in which the sensors 102 acquire acoustic information from sounds made by bats, the device 100 may be configured to acquire information (including, but not limited to, acoustic information) indicative of any other aspect of an animal of interest.

In some examples, the device 100 may include, and/or coupled to, a housing. The housing may provide protection to components of the device 100 in some examples, such as by being weatherproof and resistant to damage from being dropped. The housing may include, or be coupled to, one or more connectors or apparatus to facilitate using or deploying the device 100. For example, the housing may include straps, clips, prongs, tripod-mounting-connector, or other mounting features to enable the device 100 to be fastened to another object, such as a user's clothing or other accessories, a tripod, a vehicle, a tree, a building, and so forth. The housing may include a mounting bracket to couple to a fixture, such as a tripod, which may be capable of turning or swiveling to and maintaining a desired orientation (for example, facing a source of animal sounds). In other examples, the housing may include or be coupled to a grip to facilitate holding the device 100, such as a pistol-style grip. Such a grip may enable the user to easily maneuver the device 100 to a desired position or orientation, such as during a bat walk when the user desires to point the device 100 to a bat. In various examples, the housing may include universal mounting hardware capable of mounting to multiple different types of attachments, such as tripods, pistol grips, and so forth.

In some examples, the device 100 may have a configurable wireless range or output power. For example, a user, such as a tour guide, may adjust the wireless range of the device 100 using the interface device 118. Decreasing the wireless range may include decreasing the transmission power, which may, in turn, advantageously extend the battery life of the device 100. In some examples, the user may increase the wireless range or output power when a destination of the wirelessly transmitted information is farther, and may decrease the wireless range or output power when a destination of the information is closer. For example, one setting may correspond to a smaller required wireless range, such as a bat walk, and another setting may correspond to a larger required wireless range, such as a situation in which the device 100 is remotely deployed and left in an animal habitat.

As noted above, although the device 100 may be implemented on the go (for example, during a bat walk) or in a remote deployment (for example, in an outdoor animal habitat, in an individual's attic, in a hard-to-reach location, and so forth), other implementations are within the scope of the disclosure. For example, the device 100 may be mounted to a vehicle to collect information while the vehicle is moving or stationary. This may advantageously enable the device 100 to collect information while a user remains inside the vehicle without any wires or cables necessarily passing between the device 100 and the interior of the vehicle. In another example, the device 100 may be permanently installed in a certain physical location, such as an animal habitat. Although the device 100 may transmit collected information wirelessly via the wireless interface 106, the device 100 may, in some examples, be coupled to a wired power source via the wired interface 112. For example, the wired power source may be a generator, a renewable power source (for example, a wind turbine or solar panel), a utility grid, or another type of power source.

As discussed above, the external devices 116 may include smartphones in some examples. The interface device 118 may also include a smartphone in some examples. The interface device 118 may differ in that a leader, such as a tour guide, operates the interface device 118. The device 100 may support a configuration process by which the interface device 118 establishes itself as the leader to the device 100. For example, the device 100 may include a button or other interface component that can be actuated to establish a leader connection with the next device that attempts to pair with the device 100. Once the interface device 118 is paired as a leader device, the user of the interface device 118 may control the device 100 to configure various parameters, such as a sample rate of the sensors 102, a gain for the transmission power of the wireless interface 106 (and thus the range of the wireless signals), whether information should be wirelessly shared with other devices, what type of information should be wirelessly shared with other devices, access codes to control which users or devices can receive the information, settings to control what type of information is output by the external devices 116 (for example, spectrograms, audio signals, and so forth), and so forth. In other examples, other approaches (that is, other than implementing a physical user-interface element) may be implemented to enable a user of the interface device 118 to establish the interface device 118 as a leader device.

In some examples, when the device 100 is ready to connect to external devices such as the external devices 116 and the interface device 118, the device 100 may act as a network access point. For example, the device 100 may advertise a network SSID value to enable devices to connect to the device 100 in the same way that a device might connect to a Wi-Fi router.

As discussed above, the device 100 may be configured to wirelessly transmit information to the external devices 116 via a multicast, broadcast, unicast, or other approach. In various examples, the device 100 may broadcast wireless information to all nearby devices. In some examples, the device 100 may multicast wireless information only to those of the external devices 116 and/or interface devices 118 that have formed an authorized connection with the device 100, such as by exchanging an access code provided by the owner of the device 100. In still other examples, the device 100 may unicast wireless information to devices in a round-robin approach by transmitting the wireless information sequentially (that is, by first transmitting the wireless information to a first device, subsequently transmitting the wireless information to a second device, and so forth until the wireless information is sent to each device).

Various controllers, such as the controller 108, may execute various operations discussed above. Using data stored in associated memory and/or storage, the controller 108 also executes one or more instructions stored on one or more non-transitory computer-readable media, which the controller 108 may include and/or be coupled to, that may result in manipulated data. In some examples, the controller 108 may include one or more processors or other types of controllers. In one example, the controller 108 is or includes at least one processor. In another example, the controller 108 performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

1. A bioacoustic recording device comprising:
one or more sensors configured to sense bioacoustic information;
processing circuitry configured to process the bioacoustic information;
a wireless communication interface configured to be communicatively coupled to a plurality of external devices; and
at least one controller configured to
control the one or more sensors to sense the bioacoustic information,
control the processing circuitry to process the bioacoustic information and output processed bioacoustic information, and
control the wireless communication interface to wirelessly transmit the processed bioacoustic information to the plurality of external devices.

2. The device of claim 1, wherein the at least one controller is configured to control the wireless communication interface to broadcast the processed bioacoustic information.

3. The device of claim 1, wherein the at least one controller is configured to control the wireless communication interface to multicast the processed bioacoustic information to each external device of the plurality of external devices simultaneously.

4. The device of claim 1, wherein the at least one controller is configured to control the wireless communication interface to unicast the processed bioacoustic information to each external device of the plurality of external devices sequentially.

5. The device of claim 1, wherein the wireless communication interface is configured to be communicatively coupled to and receive instructions from an interface device, and wherein the at least one controller is further configured to pair with the plurality of external devices responsive to receiving the instructions from the interface device.

6. The device of claim 5, wherein the at least one controller is further configured to adjust a gain of a transmission power of the wireless communication interface responsive to receiving, from the interface device, instructions to adjust the gain.

7. The device of claim 5, wherein the at least one controller is further configured to adjust a sample rate of the one or more sensors responsive to receiving, from the interface device, instructions to adjust the sample rate.

8. A method of wirelessly transmitting bioacoustic information from a bioacoustic recording device, the method comprising:
sensing, by one or more sensors of the bioacoustic recording device, bioacoustic information;
processing, by processing circuitry of the bioacoustic recording device, the bioacoustic information to output processed bioacoustic information; and
wirelessly transmitting, via a wireless communication interface, the processed bioacoustic information to a plurality of external devices.

9. The method of claim 8, further comprising broadcasting, by the wireless communication interface, the processed bioacoustic information.

10. The method of claim 8, further comprising multicasting, by the wireless communication interface, the processed bioacoustic information to each external device of the plurality of external devices simultaneously.

11. The method of claim 8, further comprising unicasting, by the wireless communication interface, the processed bioacoustic information to each external device of the plurality of external devices sequentially.

12. The method of claim 8, further comprising:
receiving, from an interface device via the wireless communication interface, instructions to pair with the plurality of external devices; and
pairing the bioacoustic recording device with the plurality of external devices responsive to receiving the instructions from the interface device.

13. The method of claim 12, further comprising adjusting a gain of a transmission power of the wireless communication interface responsive to receiving, from the interface device, instructions to adjust the gain.

14. The method of claim 12, further comprising adjusting a sample rate of the one or more sensors responsive to receiving, from the interface device, instructions to adjust the sample rate.

15. A non-transitory computer-readable medium storing thereon sequences of computer-executable instructions for wirelessly transmitting bioacoustic information from a bioacoustic recording device, the sequences of computer-executable instructions including instructions that instruct at least one processor to:
control one or more sensors to sense bioacoustic information,
control processing circuitry to process the bioacoustic information and output processed bioacoustic information; and
control a wireless communication interface to wirelessly transmit the processed bioacoustic information to a plurality of external devices.

16. The non-transitory computer-readable medium of claim 15, wherein the at least one processor is configured to control the wireless communication interface to broadcast the processed bioacoustic information.

17. The non-transitory computer-readable medium of claim 15, wherein the at least one processor is configured to control the wireless communication interface to multicast the processed bioacoustic information to each external device of the plurality of external devices simultaneously.

18. The non-transitory computer-readable medium of claim 15, wherein the at least one processor is configured to control the wireless communication interface to unicast the processed bioacoustic information to each external device of the plurality of external devices sequentially.

19. The non-transitory computer-readable medium of claim 15, wherein the at least one processor is further configured to adjust a gain of a transmission power of the wireless communication interface responsive to receiving, from an interface device, wireless instructions to adjust the gain.

20. The non-transitory computer-readable medium of claim 19, wherein the at least one processor is further configured to adjust a sample rate of the one or more sensors responsive to receiving, from the interface device, instructions to adjust the sample rate.
